(19) United States
(12) Patent Application Publication
(10) Pub. No.: US 2026/0315870 A1
(43) Pub. Date: Oct. 15, 2026

(54) METHOD FOR VISUALIZING BALL TRAJECTORY IN IMAGE OF USER'S GOLF SHOT AND BALL TRAJECTORY VISUALIZATION DEVICE BASED ON RADAR SENSING USING THE SAME

(71) Applicant: GOLFZON CO., LTD., Seoul (KR)

(72) Inventors: Soo Ho CHANG, Seoul (KR); Jae Hong KIM, Seoul (KR); Shin Wook YOUN, Seoul (KR); Yong Beom AHN, Daejeon (KR)

(73) Assignee: GOLFZON CO., LTD., Seoul (KR)

(21) Appl. No.: 19/482,802

(22) PCT Filed: May 8, 2024
(86) PCT No.: PCT/KR2024/006148

§ 371 Date: Nov. 10, 2025

(30) Foreign Application Priority Data
May 11, 2023 (KR) 10-2023-0061128

(51) Int. Cl. A63B 24/00; A63B 71/06; A63B 102/32

(52) U.S. Cl. CPC A63B 24/0021; A63B 71/0622; A63B 2024/0031; A63B 2024/0034; A63B 2102/32; A63B 2220/807; A63B 2220/89

(57) ABSTRACT

It is an object of the present invention to provide a method for visualizing ball trajectory in an image of a user's golf shot and a ball trajectory visualization device based on radar sensing using the same, that detects an initial position of a golf ball placed on a ground for a golf shot by the user using a camera-captured image for photographing the user's golf shot and providing it to the user, and visualizes the movement trajectory of the golf ball calculated using the radar sensing result for the golf ball moving by the hit as an accurate ball trajectory starting from the initial position of the golf ball in the image.

### TECHNICAL FIELD

The present invention is related to a method for visualizing ball trajectory in an image of a user's golf shot and a ball trajectory visualization device based on radar sensing using the same, that may visualize a ball trajectory moving from an exact initial position of a golf ball on a captured image of the user's golf shot with a golf club by using the captured image and a radar sensing result for the user's golf shot.

### BACKGROUND ART

In golf, when a user hits a golf ball by taking a golf shot with a golf club, it is quite difficult to visually check the golf ball flying because the very small golf ball flies a fairly long distance at a very high speed.

Since it is difficult to see the golf ball flying with the naked eye, it is very difficult to check the trajectory of the golf ball even in a video of the user taking the golf shot at a certain position.

In systems such as a screen golf, when the user takes the golf shot toward the screen in front of a narrow space, the camera sensor senses the initial speed, direction, and height of the golf ball hit by the golf club, and calculates the trajectory of the entire golf ball by physical calculation based on its initial golf ball movement characteristics.

However, this is different from the trajectory of the actual moving golf ball because it is a trajectory estimated by calculation, not by measuring the actual movement of the golf ball.

A camera sensor is sometimes used to sense the trajectory of a golf ball, and since the camera sensor has a very narrow sensing range, it has no choice but to sense the movement characteristics of the initial interval in which the golf ball moves, it is not suitable for sensing the movement trajectory of the golf ball according to the golf shot in a large place such as an actual golf course.

A radar sensor are widely used as a representative sensing device that detects the movement of golf balls according to golf shots in actual golf courses.

The radar sensor is a device that analyzes the movement vector of the golf ball by receiving the radar signal changed by the Doppler shift of the radar when the radar signal emitted toward the moving golf ball is reflected from the golf ball.

Using such a radar sensor, the moving trajectory of the golf ball moving by the user's golf shot may be calculated. Since the radar sensor uses the Doppler shift phenomenon of the radar signal, it is possible to obtain phase shift information due to position changes by the movement of the golf ball, and calculate a movement trajectory by using information on a change in the position of the golf ball from when the golf ball moves. However, there is a problem that the radar sensor cannot confirm the position of the golf ball in the front-rear direction, and an initial position of the golf ball (i.e., the position of the golf ball in a stationary state placed on the bottom or tee) for the golf shot cannot be confirmed by the radar sensor.

For this reason, even if the radar sensor detects the movement of the golf ball and calculates the movement trajectory, there is a problem that the movement trajectory of the golf ball starting from a different position than the actual initial position of the golf ball is calculated.

Since the radar sensor cannot determine the initial position of the golf ball, a movement trajectory starting from the initial position of the golf ball can be completed only when the golf ball is hit at a fixed location on the reference distance in advance. However, when the user places the golf ball at an arbitrary position and takes a golf shot, the radar sensor has a problem that the starting position of the golf ball movement trajectory is significantly different from the actual one, resulting in a significant error in the overall trajectory.

Attempts are being made to compensate for each other's shortcomings by mixing camera sensing methods and radar sensing to calculate the trajectory of the ball moving as the user hits the ball with the golf club. In order to detect the initial position of a golf ball placed at an arbitrary position, a stereoscopic camera system (a camera system in which two or more cameras installed at different locations detect the same subject and calculate a position in the three-dimensional space of the subject) can be used. However, it is necessary to develop equipment that can accurately visualize the movement trajectory of a golf ball by radar sensing without using a stereoscopic camera system by two or more cameras because the price of the equipment rises significantly when the stereoscopic camera system and radar sensing system are implemented as one equipment.

Prior Art Documents related to the present invention are as follows:
Korean Patent Registration No. 10-1845503
Korean Patent Registration No. 10-2335944
Korean Patent Registration No. 10-2353481
Korean Patent Registration No. 10-2033703

### DISCLOSURE

### Technical Problem

It is an object of the present invention to provide a method for visualizing ball trajectory in an image of a user's golf shot and a ball trajectory visualization device based on radar sensing using the same, that detects an initial position of a golf ball placed on a ground for a golf shot by the user using a camera-captured image for photographing the user's golf shot and providing it to the user, and visualizes the movement trajectory of the golf ball calculated using the radar sensing result for the golf ball moving by the hit as an accurate ball trajectory starting from the initial position of the golf ball in the image.

### Technical Solution

In accordance with an aspect of the present invention, the above and other objects can be accomplished by the provision of a method for visualizing ball trajectory in an image captured by a camera while a user hits a golf ball with a golf club using radar sensing results, the method comprising: setting a ball sensing area for sensing the golf ball using the camera-captured image on a ground where the user will make a golf shot; detecting a ball object corresponding to the golf ball within the ball sensing area on the camera-captured image to calculate coordinates of an initial ball position, and determining coordinates of an actual initial position of the golf ball corresponding to the coordinates of the initial ball position; collecting radar sensing data for the golf ball moving according to the user's golf shot based on the coordinates of the actual initial position of the golf ball; and displaying a ball trajectory starting from the coordinates of the initial ball position or corrected coordinates of the initial ball position in the camera-captured image using the collected radar sensing data for the golf ball.

The camera is a single camera with a single view, and the setting the ball sensing area includes: storing coordinate matching information by matching coordinates of elements capable of specifying an area of a predetermined size on the image captured by the single camera with coordinates in actual space, and setting the area of the predetermined size on the image as the ball sensing area.

The camera is a single camera with a single view, and the setting the ball sensing area includes: storing coordinate matching information by matching the coordinates of elements capable of specifying dimensions of a structure that appears in the image captured by the single camera from the rear with a field of view that includes the structure whose dimensions are known in advance on the ground where the golf shot will be made, with coordinates in actual space, and setting the area corresponding to the structure that appears in the image as the ball sensing area.

The determining coordinates of the actual initial position of the golf ball includes: detecting the ball object corresponding to the golf ball within the set ball sensing area on the image captured by the single camera, determining the position coordinates of the ball object as the coordinates of the initial ball position using coordinate information on the ball sensing area, converting the coordinates of the initial ball position into the coordinates of the actual initial position of the golf ball, which are the actual spatial coordinates of the golf ball, using the coordinate matching information.

The method further comprises pre-setting a height of a tee to be used by the user when making a golf shot, wherein the calculating the position coordinates of the ball object as the ball initial position coordinates comprises: recognizing the preset tee height; applying height information from the image corresponding to the recognized tee height to the position coordinates of the ball object detected within the ball sensing area to calculate the coordinates of the initial ball position coordinates.

The collecting radar sensing data for the moving golf ball includes collecting golf ball orientation information including a horizontal direction angle and a vertical height angle the golf ball in the actual space at the time of receiving the radar signal reflected from the golf ball, and the displaying the ball trajectory includes displaying the ball trajectory starting from the coordinates of the initial ball position by converting each collected golf ball orientation information into coordinate information on the camera-captured image based on the coordinates of the initial ball position and connecting the converted coordinates.

The displaying the ball trajectory includes: verifying the coordinates of the initial ball position on the camera-captured image using radar sensing data at the time the golf ball is hit; correcting the coordinates of the initial ball position based on the result of the verification; and converting radar sensing data collected for the golf ball moving from an impact time of the golf ball into coordinate information on the camera-captured image to display the ball trajectory starting from the corrected coordinates of the initial ball position on the image.

The collecting radar sensing data for the moving golf ball includes: generating a trigger signal at the time point of hitting the golf ball; and collecting golf ball orientation information including an up-down height angle and a left-right direction angle of the golf ball moving in actual space from the time point of generation of the trigger signal at the time of receiving the radar signal reflected from the moving golf ball, and the displaying the ball trajectory includes: converting the golf ball orientation information at the time of generation of the trigger signal into coordinate information on the camera-captured image based on the coordinates of the initial ball position to generate ball coordinates at the trigger time point; correcting the coordinates of the initial ball position using the ball coordinates at the trigger time point; and converting the golf ball orientation information collected for the moving golf ball from the trigger time point into coordinate information on the camera-captured image based on the corrected coordinates of the initial ball position, and displaying the ball trajectory starting from the corrected coordinates of the initial ball position by connecting the converted coordinates.

The collecting radar sensing data for the moving golf ball includes: generating a trigger signal at the time point of hitting the golf ball; and collecting golf ball orientation information including an up-down height angle and a left-right direction angle of the golf ball moving in actual space from the time point of generation of the trigger signal at the time of receiving the radar signal reflected from the moving golf ball, and wherein the displaying the ball trajectory includes: determining three-dimensional position information of the golf ball at the time of generating the trigger signal using the golf ball orientation information at the time of generating the trigger signal and the actual initial position coordinates of the golf ball; converting the calculated three-dimensional position information of the golf ball into coordinate information on the camera-captured image to calculate corrected coordinate information of the coordinates of the initial ball position; and converting the golf ball orientation information collected for the moving golf ball from the trigger time point into coordinate information on the camera-captured image based on the corrected coordinates of the initial ball position, and displaying the ball trajectory starting from the corrected coordinates of the initial ball position by connecting the converted coordinates.

In accordance with another aspect of the present invention, there is provided a ball trajectory visualization device based on radar sensing comprising: a single camera capturing an image of a user performing a golf shot from behind a bottom on which the user is to perform the golf shot; a sensing processor that sets a ball sensing area for sensing a golf ball using the image captured by the single camera, detects a ball object corresponding to the golf ball within the ball sensing area on the captured image to calculate coordinates of initial ball position, and determines actual initial position coordinates of the golf ball corresponding to the coordinates of the initial ball position; a radar sensor that collects radar sensing data for the golf ball moving according to the user's golf shot based on the actual initial position coordinates of the golf ball; and a trajectory displaying processor that displays a ball trajectory starting from the coordinates of the initial ball position or corrected coordinates of the initial ball position in the camera-captured image using the collected radar sensing data for the golf ball.

The sensing processor is configured to: match coordinates of elements capable of specifying dimensions of a structure on the image captured by the single camera with a field of view including the structure with known the dimensions placed on the bottom, with coordinates in actual space to store coordinate matching information; set an area corresponding to the structure shown on the image as the ball sensing area; detect a ball object corresponding to the golf ball within the set ball sensing area on the image captured by the single camera; determine the position coordinates of the ball object as coordinates of the initial ball position using coordinate information on the ball sensing area; and convert the coordinates of the initial ball position into the actual initial position coordinates of the golf ball, which is the actual spatial coordinates of the golf ball, using the coordinate matching information.

The sensing processor is configured to: preset a height of a tee to be used when the user takes a golf shot; match coordinates of elements capable of specifying dimensions of a structure on the image captured with a field of view including the structure with known the dimensions placed on the bottom, with coordinates in actual space to store coordinate matching information; set an area corresponding to the structure shown on the image as the ball sensing area; detect a ball object corresponding to the golf ball within the set ball sensing area on the image captured by the single camera; calculate the position coordinates of the ball object using coordinate information on the ball sensing area; recognize the preset tee height and apply the height information on the image corresponding to the recognized tee height to the position coordinates of the ball object to calculate the coordinates of the initial ball position; and convert the coordinates of the initial ball position into the actual initial position coordinates of the golf ball, which is the actual spatial coordinates of the golf ball, using the coordinate matching information.

The radar sensor is configured to collect golf ball orientation information including a vertical height angle and a horizontal direction angle on the actual space of the golf ball at the time of receiving the radar signal reflected from the golf ball, and wherein the trajectory displaying processor is configured to convert each golf ball orientation information collected by the radar sensor into coordinate information on the camera-captured image based on the coordinates of the initial ball position and connect the converted coordinates to display the ball trajectory starting from the coordinates of the initial ball position.

The trajectory displaying processor is configured to: verify the coordinates of the initial ball position on the camera-captured image using radar sensing data at the time when the golf ball is hit, and correct the coordinates of the initial ball position according to the verification result; convert the radar sensing data collected for the moving golf ball from the time point of hitting into coordinate information on the camera-captured image to display a ball trajectory starting from the corrected coordinates of the initial ball position on the image.

### Advantageous Effects

A method for visualizing ball trajectory in an image of a user's golf shot and a ball trajectory visualization device based on radar sensing using the same according to the present invention have an advantageous effect that can detect an initial position of a golf ball placed on a ground for a golf shot by the user using a camera-captured image for photographing the user's golf shot and providing it to the user, and visualize the movement trajectory of the golf ball calculated using the radar sensing result for the golf ball moving by the hit as an accurate ball trajectory starting from the initial position of the golf ball in the image.

### DESCRIPTION OF DRAWING

FIG. 1 shows a scene in which a user takes a golf shot in a state in which a ball trajectory visualization device based on radar sensing according to an embodiment of the present invention is placed on a golf course or a field equivalent thereto.

FIG. 2 is a block diagram showing a configuration of an ball trajectory visualization device based on radar sensing according to an embodiment of the present invention.

FIG. 3 shows a more specific configuration of a radar sensor and the radar signal receiver of the ball trajectory visualization device according to an embodiment of the present invention shown in FIG. 2.

FIG. 4 shows an example of calculating position information of a moving ball by the radar sensor as shown in FIG. 3.

FIG. 5 shows an example of an image taken by a single camera of the ball trajectory visualization device from a rear where the user takes a golf shot as shown in (c) of FIG. 4.

FIG. 6 shows a ball trajectory visualization device based on radar sensing according to an embodiment of the present invention for setting a ball sensing area using a structure having a known dimensions in advance. (a) of FIG. 6 shows an image in a real space, and (b) of FIG. 6 shows an image captured by a single camera of the ball trajectory visualization device in the state shown in (a) of FIG. 6.

FIG. 7 shows that a ball trajectory visualization device based on radar sensing according to an embodiment of the present invention calculates coordinates of an initial position of a golf ball by using the ball sensing area in a state in which the user places the golf ball on a ground for a golf shot. (a) of FIG. 7 shows the user (U) golf shot in a real space, and (b) of FIG. 7 shows an image taken with the single camera of the ball trajectory visualization device in the state shown in (a) of FIG. 7.

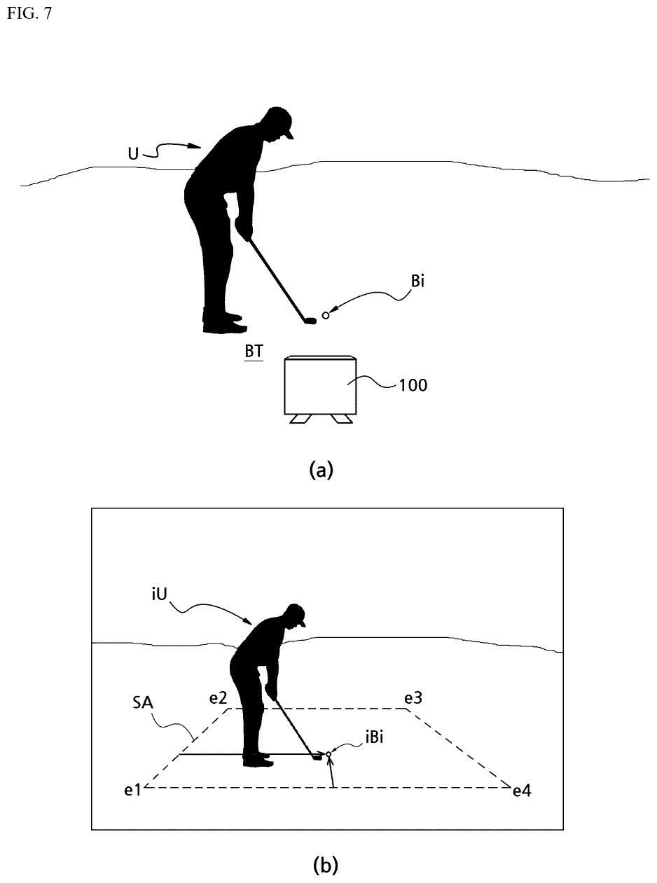

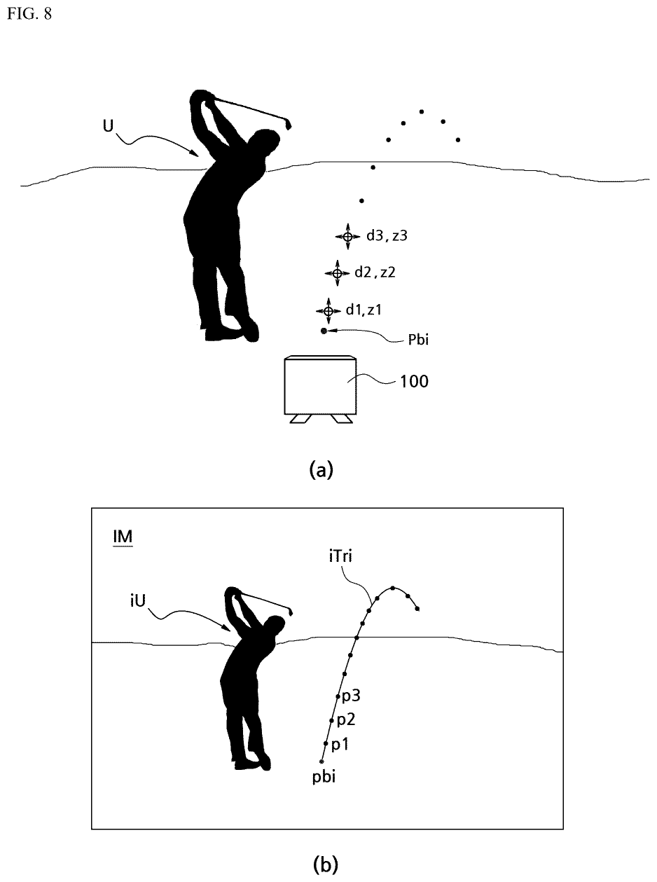

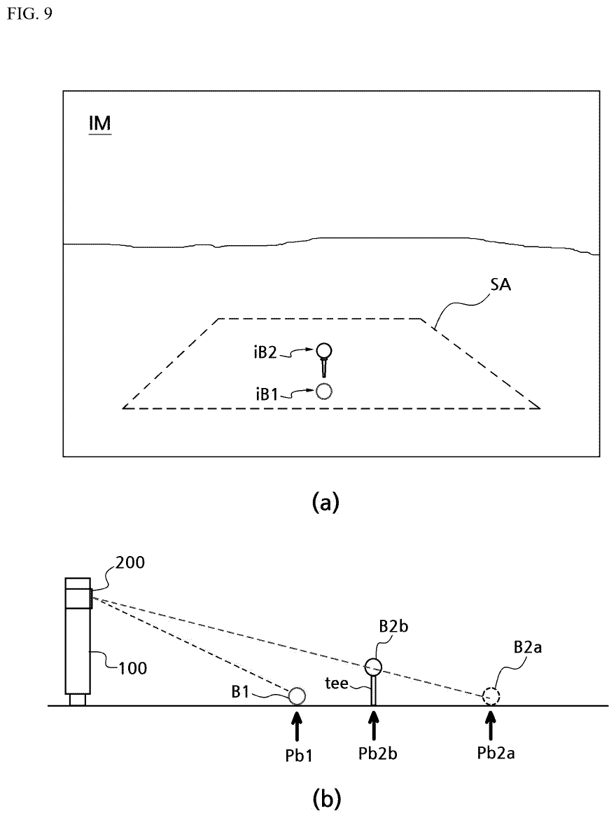

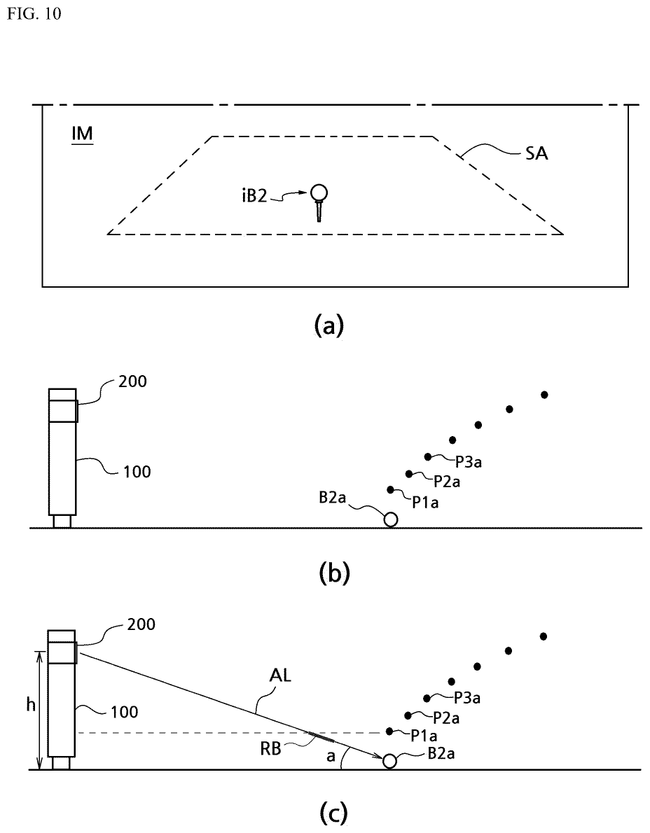

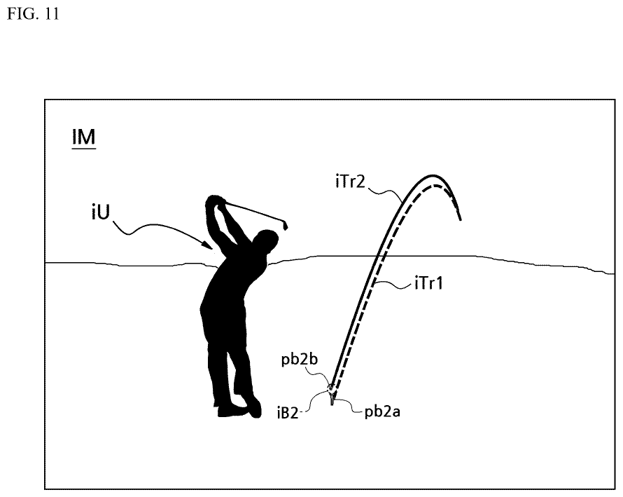

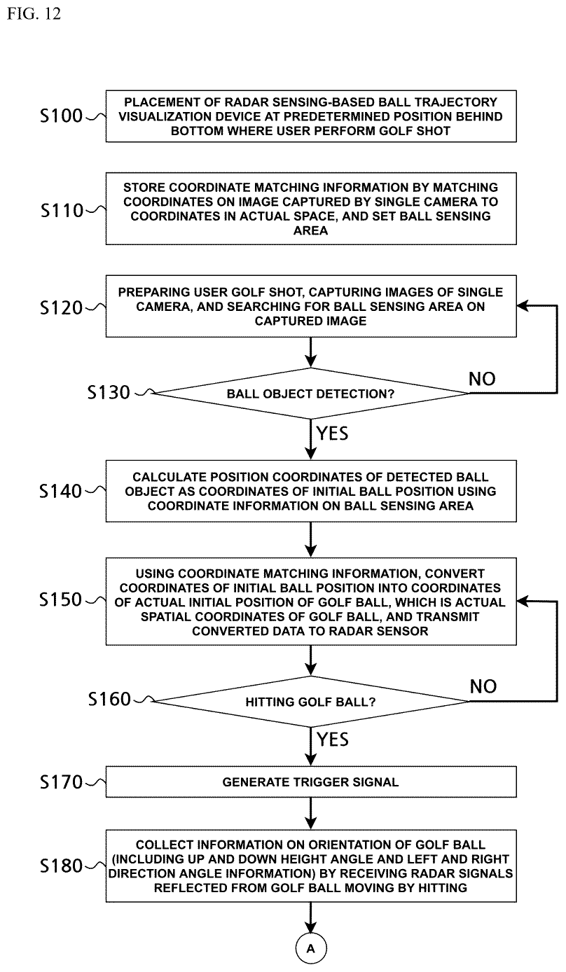

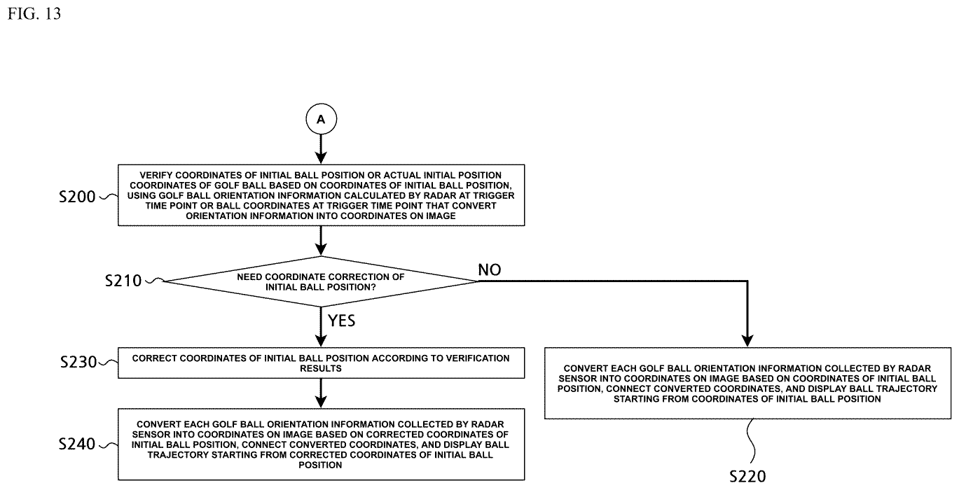

(a) of FIG. 8 shows that the user hits the golf ball in the state shown in (a) of FIG. 7 to move the golf ball, and (b) of FIG. 8 shows the ball trajectory calculated using radar sensing results in an image taken from the actual scene shown in (a) of FIG. 8 with the single camera.

(a) of FIG. 9 shows an image of a golf ball placed on the ground and a golf ball placed on a tee inserted on the ground in the ball trajectory visualization device according to an embodiment of the present invention, and (b) of FIG. 9 shows the relationship between a gaze of the single camera and the position of the golf ball seen from the side.

FIG. 10 shows a case in which there may be an error in the coordinates of the initial ball position calculated through the image in the ball trajectory visualization device according to an embodiment of the present invention and a method of correcting the error.

FIG. 11 shows a ball trajectory shown based on the coordinates of the initial ball position originally calculated in the single camera image of the golf ball flying as the user hits the golf ball and another ball trajectory shown by correcting the coordinates of the initial ball position to a more accurate position.

FIG. 12 is a flowchart showing a process of a method for visualizing a ball trajectory in a golf shot image of a user using a ball trajectory visualization device according to an embodiment of the present invention. FIG. 13 is a flowchart showing the process of the method for visualizing the ball trajectory following FIG. 12.

### BEST MODEL

A method for visualizing ball trajectory in an image of a user's golf shot and a ball trajectory visualization device based on radar sensing using the same according to the present invention will be described in detail with reference to the accompanying drawings.

The method for visualizing ball trajectory in an image of a user's golf shot and a ball trajectory visualization device based on radar sensing using the same according to an embodiment of the present invention acquire and provide an image of a scene in which a user takes a golf shot with a golf club outdoors such as a golf course, wherein the present invention may sense a golf ball that is hit and flies by the golf shot using a radar, and visualize the ball trajectory according to the sensing result on the acquired image.

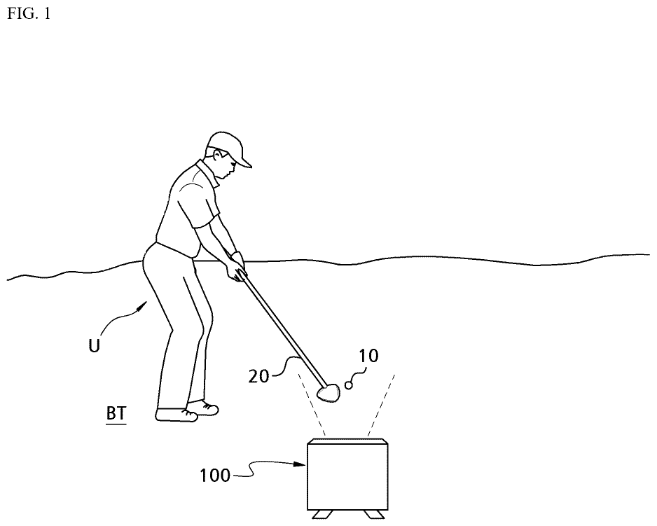

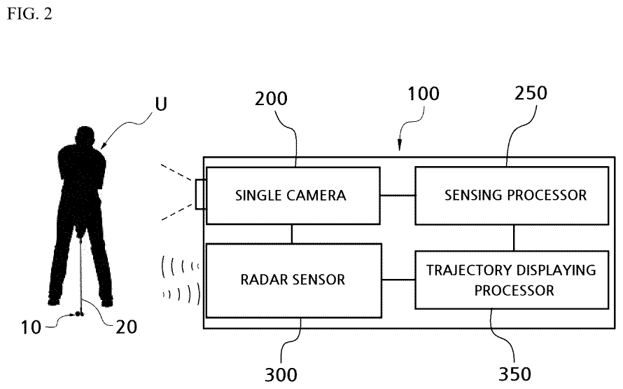

A configuration of the ball trajectory visualization device based on radar sensing according to an embodiment of the present invention will be described with reference to FIGS. 1 and 2.

FIG. 1 shows a scene in which a user takes a golf shot in a state in which a ball trajectory visualization device based on radar sensing according to an embodiment of the present invention is placed on a golf course or a field equivalent thereto. FIG. 2 is a block diagram showing a configuration of an ball trajectory visualization device based on radar sensing according to an embodiment of the present invention.

The ball trajectory visualization device 100 based on radar sensing according to an embodiment of the present invention is configured to include a single camera 200 with a single view, a sensing processor 250 that calculates position information of the golf ball from the image acquired by the single camera, a radar sensor 300 that collects radar sensing data for the golf ball that is hit and moved, and a trajectory displaying processor 350 for displaying a ball trajectory on the acquired image of the single camera by using radar sensing data collected by the radar sensor.

As shown in FIG. 1, the ball trajectory visualization device 100 according to an embodiment of the present invention may be used by being placed in a direction toward a front from a rear of a bottom BT at which the user U holds the golf club 20 and hits the golf ball 10 (i.e., the direction in which the golf ball flies by hitting).

The single camera 200 of the ball trajectory visualization device 100 may acquire an image of a scene in which the user U performs a golf shot from the rear to the front of the bottom BT on which the user U will perform a golf shot in a single perspective.

The image of the user's golf shot scene is a simple two-dimensional image of a single camera, and is not an image acquired in multiple perspectives by a plurality of cameras of stereoscopic system.

It is possible to obtain information that cannot be obtained from radar sensing data because position information on the golf ball in the three-dimensional space can be calculated through image analysis when an image of the golf ball is acquired by multiple stereoscopic cameras. However, since the radar sensor itself is also quite expensive and the stereoscopic camera system is also quite expensive, it is difficult to commercialize these two systems because implementing them as one equipment will increase the cost very significantly.

The ball trajectory visualization device based on radar sensing according to an embodiment of the present invention uses a single camera basically required to provide an image for a user's golf shot scene. The present invention may calculate information necessary for visualizing the ball trajectory equal to or higher than that acquired by using a stereoscopic camera system using a single camera, and may accurately display the ball trajectory on the image captured by the single camera by using the information together with a radar sensing result.

Information necessary for visualizing the ball trajectory calculated using the single camera as described above may be calculated by the sensing processor 250 through the user's golf shot scene photographing image acquired by the single camera 200.

That is, the sensing processor 250 of the ball trajectory visualization device according to an embodiment of the present invention may perform processes including: setting a ball sensing area for sensing a golf ball using the image acquired by the single camera 200, determining coordinates of the initial ball position by detecting a ball object corresponding to the golf ball in the ball sensing area on the acquired image, calculating the coordinates of the actual initial position of the golf ball corresponding to the coordinates of the initial ball position, and transmitting the coordinates of the actual initial position of the golf ball to the radar sensor 300.

The radar sensor 300 of the ball trajectory visualization device according to an embodiment of the present invention may collect radar sensing data for the golf ball moving according to the user's golf shot based on the coordinates of the actual initial position of the golf ball received from the sensing processor 250 as described above. The trajectory displaying processor 350 may display the ball trajectory starting from the coordinates of the initial ball position on the camera acquisition image on the corresponding image by using radar sensing data for the golf ball collected by the radar sensor 300.

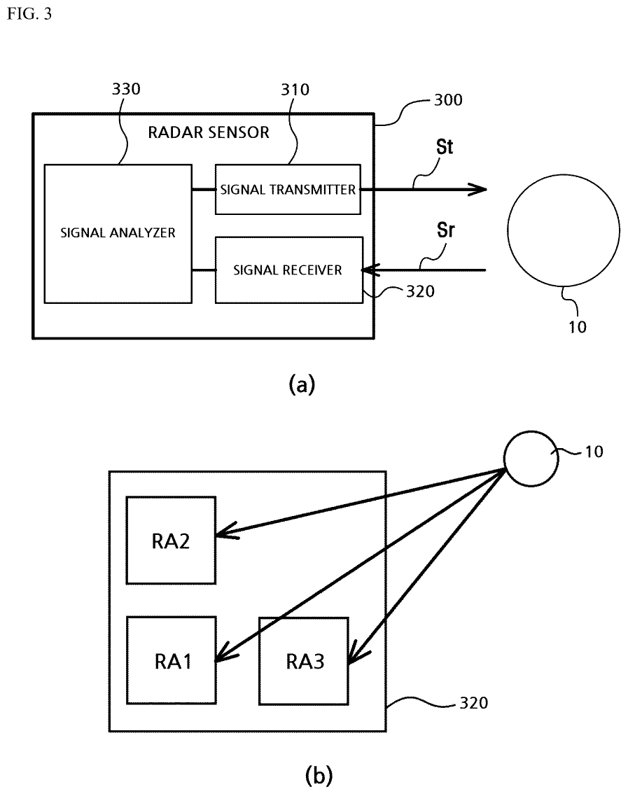

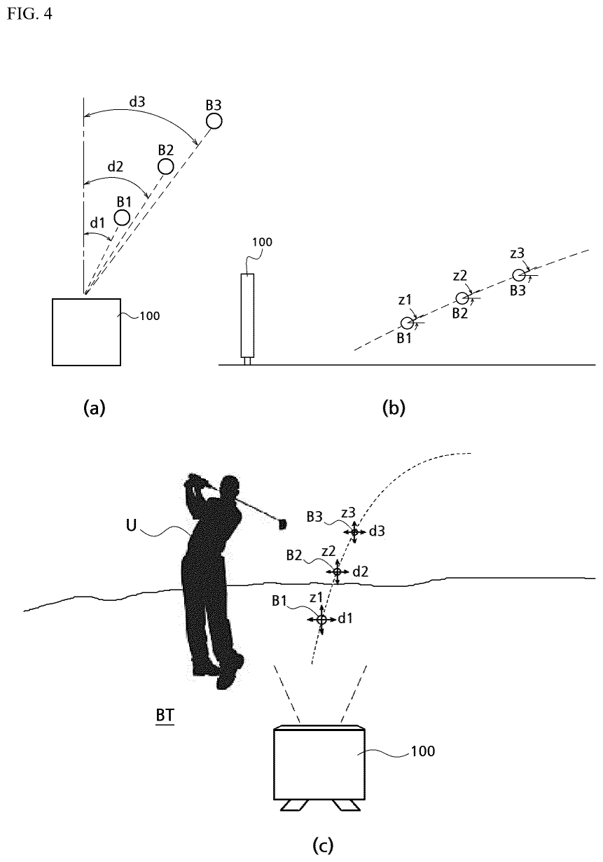

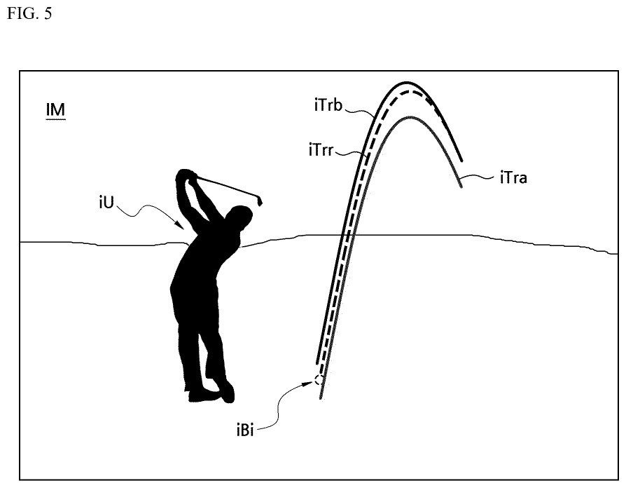

The overall operation of the ball trajectory visualization device according to the embodiment of the present invention as described above will be described later. First, a process of obtaining radar sensing data from a moving golf ball by the radar sensor 300 of the ball trajectory visualization device according to the embodiment of the present invention will be described with reference to FIGS. 3 and 4.

FIG. 3 shows a more specific configuration of a radar sensing part and the radar signal receiver of the ball trajectory visualization device according to an embodiment of the present invention shown in FIG. 2. FIG. 4 shows an example of calculating position information of a moving ball by the radar sensing part as shown in FIG. 3.

The radar sensor 300 may basically calculate a phase change and position information at each measurement point of the golf ball that is hit and moved using the Doppler effect of radar signal.

As shown in FIG. 3(a), the radar sensor 300 may include a signal transmitter 310, a signal receiver 320, and a signal analyzer 330.

The radar sensor 300 may be configured to transmit a radar signal of a specific frequency toward the moving direction of the golf ball that will be moved by hitting at a position behind the golf ball by a predetermined distance, receive and analyze reflected waves reflected from the moving golf ball, and track the moving golf ball.

The signal transmitter 310 is configured to transmit a specific radar signal St in an aimed direction, and may include a transmission antenna that transmits the specific radar signal, although not shown in the drawing.

The signal receiver 320 is configured to receive the reflected wave signal Sr that the radar signal St transmitted by the signal transmitter 310 is reflected from the moving golf ball 10 and returns. The reflected wave signal Sr transmitted by the signal transmitter 310 and reflected from the golf ball 10 by the Doppler effect is a signal in which a Doppler shift occurs due to a change in a frequency of the signal transmitted by the signal transmitter 310. That is, the signal receiver 320 receives a signal in which a Doppler shift occurs.

The signal receiver 320 includes a plurality of receiving antennas for receiving reflected wave signals, and may calculate the position information of the golf ball using the phase difference of the receiving signal of each receiving antenna.

FIG. 3(b) briefly illustrates an example of the above-described configuration of the signal receiver 320. As shown, the signal receiver 320 can properly arrange and provide three or more receiving antennas including RA1, RA2, and RA3, and can calculate an angle of height and a direction angle of the moving golf ball 10 using the phase difference of the signal between each receiving antenna, respectively.

For example, in the signal receiver 320 shown in FIG. 3(b), the vertical height angle of the moving golf ball 10 can be calculated using the phase difference of the signals received by RA1 and RA2, and the horizontal direction angle of the moving golf ball 10 can be calculated using the phase difference of the signals received by RA1 and RA3.

The signal analyzer 330 may calculate phase information by analyzing the radar signal reflected by the golf ball at predetermined time intervals when the golf ball moves, and may be configured to collect the orientation information (including up and down height angle and left and right direction angle information) of the moving golf ball at predetermined time intervals as radar sensing data.

FIG. 4(a) shows that the radar sensor of the ball trajectory visualization device 100 according to an embodiment of the present invention measures left-right directions (d1, d2, d3 . . . ) at each measurement position (B1, B2, B3 ...) of the moving golf ball, and FIG. 4(b) shows that the radar sensor measures the vertical height angles (z1, z2, z3 . . . ) at each measurement position (B1, B2, B3 . . . ) of the moving golf ball.

As shown in FIG. 4(a) and 4(b), the radar sensor of the ball trajectory visualization device 100 according to an embodiment of the present invention may calculate and collect left and right directional angle and vertical height angle information for each measurement position when receiving the reflected wave signal of the radar signal from the moving golf ball.

That is, as in the example shown in FIG. 4(c), when the golf ball hit by the user (U) moves after a golf shot, the radar sensor can collect, as radar sensing data, golf ball orientation information (left and right direction angles and up and down height angle information) including, for example, (d1, z1) data at position B1, (d2, z2) data at position B2, and (d3, z3) data at position B3.

However, the orientation information of the golf ball collected by the radar sensor on the moving golf ball is angle information in the left and right directions of the golf ball in real three-dimensional space (see FIG. 4(a)) and angle in the vertical direction of the golf ball (see FIG. 4(b)), and information on the front and rear direction of the golf ball is difficult to confirm through radar sensing data.

Using the left-right direction angle and up-down height angle information of the moving golf ball by radar as described above, it is possible to convert the golf ball orientation information at each measurement point into coordinate information on the image, and connect each conversion coordinates on the golf shot image, a two-dimensional image captured by the single camera, to derive the ball trajectory itself.

However, as described above, it is difficult to measure the position information of the moving golf ball in the front and rear direction, such as where the golf ball is in front of the device by radar sensing, so it is difficult to know where the ball trajectory for the moving golf ball starts.

As shown in FIG. 4(c), FIG. 5 shows an example of an image IM taken by the single camera of the ball trajectory visualization device 100 from the rear where the user U takes a golf shot, and in FIG. 5, the “iU” is the part corresponding to the user on the image, and “iBi” is the object part corresponding to the golf ball placed at the initial position.

In FIG. 5, when the user iU hits the ball iBi at an initial ball position, if the ball trajectory is calculated and displayed accurately, it can be represented by the iTrr trajectory indicated by a dotted line. However, if the ball trajectory is calculated by collecting radar sensing data for the moving golf ball, it can be represented by the iTra trajectory or iTrb trajectory shown in FIG. 5 when the exact initial position of the ball is not known. It can be seen that the iTra trajectory or iTrb trajectory has a significant difference from the actual ball trajectory iTrr trajectory.

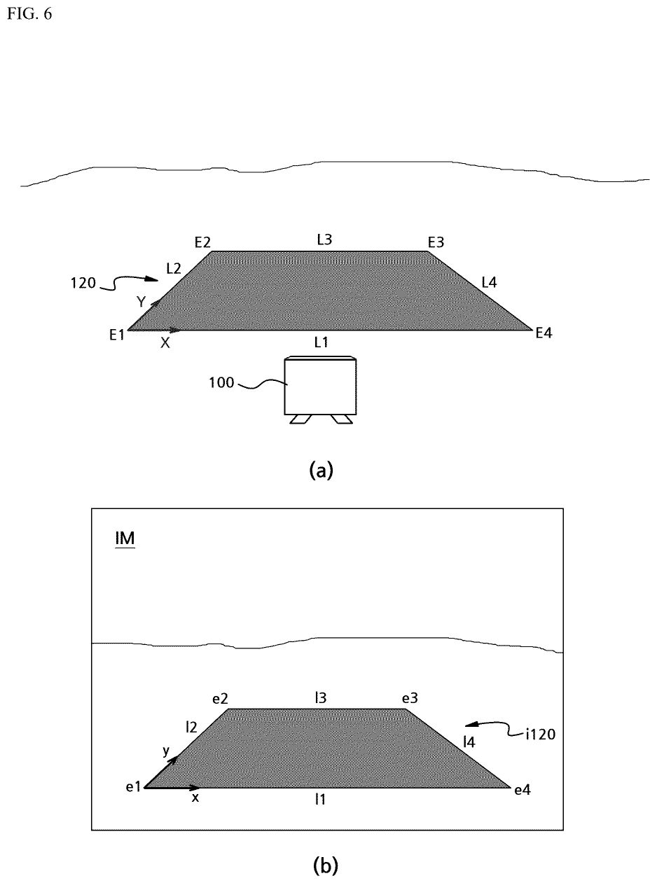

The ball trajectory visualization device according to an embodiment of the present invention is characterized in that the initial position of the ball is accurately recognized from the image captured by the single camera, and the ball trajectory calculated using radar sensing data is displayed on the image so as to be accurately displayed as a trajectory starting from the recognized initial position of the ball. Such features of the present invention will be described in more detail with reference to FIGS. 6 to 8.

The sensing processor of the ball trajectory visualization device according to an embodiment of the present invention may set a ball sensing area to specify the position coordinates of the golf ball to be placed at an arbitrary position on the bottom where the user will play the golf shot through the image acquired by the single camera.

The sensing processor may match coordinates of elements capable of specifying an area of a predetermined size on an image acquired by the single camera with coordinates in an actual space, and store the coordinate matching information. The sensing processor may set the area of the predetermined size on the image as a ball sensing area.

As an example of a method for obtaining the above ‘coordinates of elements capable of specifying an area of a predetermined size’, a ‘structure that knows dimensions in advance’ can be used, for example, a square structure that knows the length of four sides accurately.

FIG. 6 shows a ball trajectory visualization device based on radar sensing according to an embodiment of the present invention for setting a ball sensing area using a structure having a known dimensions in advance. FIG. 6(a) shows an image in a real space, and FIG. 6(b) shows an image captured by a single camera of the ball trajectory visualization device in the state shown in FIG. 6(a).

FIG. 6(a) shows a state in which the rectangular structure 120 is disposed within the field of view of the camera as the above-described ‘structure with a known dimensions in advance’.

The rectangular structure 120 shown in FIG. 6(a) is a structure in which the lengths of the four sides, that is, L1, L2, L3, and L4, are known in advance, and as shown in FIG. 6(b), the lengths L1, L2, L3, and L4 of each side correspond to the lengths l1, l2, l3, and l4, which are the lengths of the four sides of the square i120 on the image IM, respectively.

In addition, the four vertices E1, E2, E3, and E4 are the factors that can specify the dimensions of the square structure 120 shown in FIG. 6(a), and these correspond to the four vertices e1, e2, e3, and e4, respectively, which can specify the dimensions of the square i120 on the image shown in FIG. 6(b).

When an x-y coordinate system having the el position as an origin is defined on the image IM of FIG. 6(b), the position coordinates of each vertex of e1, e2, e3, and e4 may be specified in the x-y coordinate system. That is, the coordinates of the el may be specified as (0, 0), the coordinates of the e2 may be specified as (0, l2), the coordinates of the e3 may be specified as (l3(=l1), l4(=l2), and the coordinates of the e4 may be specified as (l1, 0).

As described above, the position coordinates of each vertex of e1, e2, e3, and e4 specified may be matched with the coordinates of each vertex of the structure 120 in the actual space as shown in FIG. 6(a).

That is, in the X-Y coordinate system with the E1 position as the origin in the actual space as shown in FIG. 6(a), the coordinates of the E1 can be specified as (0, 0), the coordinates of the E2 as (0, L2), the coordinates of the E3 as (L3(=L1), L4(=L2)), and the coordinates of the E4 as (L1, 0), and coordinate matching information can be derived by matching the position coordinates of each of E1, E2, E3, and E4 with the position coordinates of each of e1, e2, e3, and e4 on the image.

As described above, coordinate matching information that matches the coordinates of elements specified in the image and the coordinates in the actual space can be stored and used importantly in the process of visualizing the ball trajectory according to the user's golf shot.

The area specified by e1, e2, e3, and e4 on the image IM is an x-y coordinate plane, which can be specified as x-y coordinates at any position within the x-y coordinate plane, and the x-y coordinates specified in this way can be converted into coordinate information in the actual space by the above coordinate matching information.

As described above, the sensing processor of the ball trajectory visualization device according to an embodiment of the present invention may set an area specified by e1, e2, e3, and e4 on the image IM as the ‘ball sensing area’.

As described above, after the setting of the ‘ball sensing area’ is completed, the structure may be removed and the process of visualizing the ball trajectory according to the user's golf shot may start.

FIG. 7 shows that a ball trajectory visualization device based on radar sensing according to an embodiment of the present invention calculates coordinates of an initial position of a golf ball by using the ball sensing area in a state in which the user places the golf ball on a ground for a golf shot. FIG. 7(a) shows the user U golf shot in a real space, and FIG. 7(b) shows an image taken with the single camera of the ball trajectory visualization device in the state shown in FIG. 7(a).

As shown in FIG. 7(a), when the user U places the golf ball Bi on the bottom BT for a golf shot while the ball trajectory visualization device 100 according to the present invention is installed, the ball sensing area SA specified by e1, e2, e3, and e4 is set in advance in the image photographing the scene as shown in FIG. 7(b), and thus the object corresponding to the golf ball in the ball sensing area SA, i.e., a ball object iBi may be detected within the ball sensing area SA to calculate position coordinate information on the ball sensing area SA of the ball object iBi.

In this way, the position coordinates of the ball object iBi in the ball sensing area SA on the image will be referred to as “coordinates of initial ball position”.

If the position coordinates of the ball object iBi, that is, the coordinates of the initial ball position, are calculated using the preset coordinate information on the ball sensing area SA, the coordinates of the initial ball position in the image may be converted into coordinates of the actual initial position of the golf ball Bi, which is the actual spatial coordinates of the golf ball.

As described above, the ball trajectory visualization device according to an embodiment of the present invention can utilize the coordinates of the initial ball position calculated through an image acquired by the single camera as a reference point for displaying the ball trajectory. In addition, sensing data of the radar sensor can be collected and used to calculate the ball trajectory using coordinate matching information as a reference position of the actual initial position of the golf ball converted from the coordinates of the initial ball position.

FIG. 8(a) shows that the user hits the golf ball in the state shown in FIG. 7(a) to move the golf ball, and FIG. 8(b) shows the ball trajectory calculated using radar sensing results in an image taken from the actual scene shown in FIG. 8(a) with the single camera.

In FIG. 8(a), when the user U hits a golf ball by a golf shot, the ball trajectory visualization device 100 according to an embodiment of the present invention may generate a trigger signal at the time point of the hitting. According to the generation of the trigger signal, the radar sensor may continuously collect radar sensing data for the moving golf ball from the trigger time point.

Wherein the ‘radar sensing data’ described above is the orientation information (up and down height angle and left and right direction angle information) of the golf ball at each measurement point of the moving golf ball, as described above with reference to FIGS. 3 and 4.

And the radar sensor may collect the orientation information of the golf ball by setting the coordinates Pbi of the actual initial position of the golf ball as a reference position, the coordinates Pbi of the actual initial position of the golf ball are converted from the coordinates of the initial ball position detected through the ball sensing area on the image using coordinate matching information.

That is, as shown in FIG. 8(a), the radar sensor for the moving golf ball may collect orientation information (left and right direction angles, vertical height angles) such as (d1, z1), (d2, z2), (d3, z3), etc. of the golf ball at each radar measurement time. Wherein the golf ball orientation information may be measured based on the coordinates Pbi of the actual initial position of the golf ball.

The trajectory displaying processor of the ball trajectory visualization device according to an embodiment of the present invention may convert each golf ball orientation information collected by the radar sensor as described above into coordinate information on the image IM based on the coordinates pbi of the initial ball position on the image IM.

That is, each golf ball orientation information (d1, z1), (d2, z2), (d3, z3), etc. shown in FIG. 8(a) may be converted into coordinate information (p1, p2, p3, etc.) on the image IM based on the coordinates pbi of the initial ball position as shown in FIG. 8(b). For example, (d1, z1) may be converted to pl coordinates on the image, (d2, z2) may be converted to p2 coordinates on the image, and (d3, z3) may be converted to p3 coordinates on the image.

As described above, the trajectory displaying processor may accurately display the ball trajectory iTri starting from the coordinates of the initial ball position on the image IM by connecting each ball position coordinates (p1, p2, p3 . . . ) calculated based on the coordinates of the initial ball position on the image IM.

As described above, the ball trajectory visualization device according to one embodiment of the present invention may set the ball sensing area in the image captured by the single camera and store coordinate matching information, which is matching information with coordinates in actual space. The device may detect the ball object corresponding to the golf ball through the ball sensing area in the image when the user takes a golf shot, calculate the coordinates of the initial ball position, generate the trigger signal when the user hits the golf ball, and from the trigger time point onwards, the radar sensor may collect golf ball orientation information for the moving golf ball using radar sensing data. Wherein the trajectory displaying processor may convert the collected golf ball orientation information into coordinate information on the image, and connect and display the ball trajectory starting from the coordinates of the initial ball position, thereby visualizing the ball trajectory at an accurate position on the image.

However, when the user detects the ball object corresponding to the golf ball and calculates the coordinates of the initial ball position before taking a golf shot, the calculated coordinates of the initial ball position may be different from the actual golf ball position.

Because the image acquired by the single camera from a single perspective is a two-dimensional image, there is a limitation in that it is difficult to know the position information in the actual three-dimensional space. In addition, since the ball sensing area can only calculate the position on the plane, for example, if the golf ball is placed on a tee in the actual space, the coordinates of the initial ball position obtained on the image may be different from the actual one.

FIG. 9(a) shows an image of a golf ball placed on the ground and a golf ball placed on a tee inserted on the ground in the ball trajectory visualization device according to an embodiment of the present invention, and FIG. 9(b) shows the relationship between a gaze of the single camera and the position of the golf ball seen from the side.

As shown in FIG. 9(a), the position of the ball object iB1 detected within the ball sensing area SA in the image IM acquired by the single camera corresponds to the position Pb1 of the actual golf ball B1, as shown in FIG. 9(b), so the position coordinates of the ball object iB1 detected by the ball sensing area SA on the image IM, that is, the coordinates of the initial ball position, are coordinates that match the coordinates Pb1 of the initial position of the actual golf ball B1.

In this case, since the coordinates of the initial ball position of the ball object iB1 match the actual one, displaying the ball trajectory obtained using radar sensing data as a trajectory starting from the coordinates of the initial ball position on the image can provide accurate visualization of the ball trajectory.

The position of the ball object iB2 detected within the ball sensing area SA in the image IM captured by the single camera as shown in FIG. 9(a), corresponds to the position of the golf ball B2b placed on the tee as shown in FIG. 9(b). However, the golf ball B2b on the line of sight viewed by the single camera 200 is recognized as the position of the golf ball B2a placed on the plane.

Therefore, the coordinates of the initial ball position detected through the ball sensing area SA for the ball object iB2 on the image are not based on Pb2b, the actual position of the golf ball B2b, but Pb2a, the position of the golf ball B2a in a different position from the actual position, so it can be seen that an error occurred in the coordinates of the initial ball position.

In preparation for such a case, the present invention calculates the corrected coordinates of the initial ball position through a process of correcting the coordinates of the initial ball position and displays the ball trajectory based on the same. This will be described with reference to FIGS. 10 and 11.

FIG. 10(a) shows part of an image taken of the case where a golf ball is placed on a tee, and the ball trajectory visualization device according to an embodiment of the present invention recognizes the ball object iB2 on the image IM as the position of B2a placed on the bottom, as shown in FIG. 10(b), so the calculated coordinates of the initial ball position are also based on the position of the golf ball placed at a different B2a position from the actual golf ball position.

The ball trajectory visualization device according to an embodiment of the present invention may verify whether the coordinates of the initial ball position on the image are correct using radar sensing data at the time the golf ball is hit, and may proceed with the process of correcting the coordinates of the initial ball position according to the verification result.

When a trigger signal is generated at the time the golf ball is hit, the radar sensor can collect golf ball orientation information, including the vertical height angle and the horizontal direction angle on the actual space of the golf ball at the time of receiving the radar signal reflected from the golf ball from the time the trigger signal is generated.

That is, as shown in FIG. 10(b), golf ball orientation information such as P1a, P2a, P3a, and the like is collected based on the position of the B2a golf ball.

Wherein the trajectory displaying processor can verify the coordinates of the initial ball position or the coordinates of the actual initial position of the golf ball based on it and determine whether the coordinates of the initial ball position are correct position coordinates using the golf ball orientation information calculated by the radar at the trigger time point or ball coordinates at the trigger time point that convert the orientation information into coordinates on the image. The trajectory displaying processor can correct the coordinates of the initial ball position according to the verification result.

In the verification process as described above, for example, if it is determined that the coordinates based on the golf ball orientation information at the trigger time point are too far from the coordinates of the initial ball position, it can be determined that there is an error in the coordinates of the initial ball position.

Since the trigger time point is the point when the golf ball starts to move by being hit by the golf club while it is still, the position where the golf ball orientation information is converted into coordinates on the image at the trigger time point should be almost the same or very close to the initial ball position. However, if the position P1a of the golf ball at the trigger time point sensed by the radar (i.e., the ball object's position coordinates calculated through the ball sensing area on the image) is more than a certain distance from the position B2a of the coordinate of the initial ball position, as shown in FIG. 10(b), it is difficult to say that the golf ball started from the position B2a of the coordinate of the initial ball position initially obtained.

Therefore, the coordinates of the initial ball position initially obtained can be corrected with more accurate position coordinates by using the position of the golf ball at the trigger time point sensed by the radar.

For example, the height (h) information of the single camera 200 of the ball trajectory visualization device 100 and the angle (a) in the direction of the gaze at which the single camera 200 looks at the golf ball at the height are known values in advance, so these can be used to determine the line AL in the direction of the gaze at which the single camera 200 looks at the golf ball at the height of h, and the actual golf ball is located on the line AL in the direction of the gaze.

Considering the height of the golf ball's position P1a at the trigger time point, the actual golf ball's position can be found in a certain range of section RB on the line AL in the gaze direction below the height of the golf ball's position P1a.

When the golf ball is stopped, the Doppler shift of the radar does not occur, so the position cannot be confirmed with radar sensing data, and the position of the golf ball can only be confirmed when the movement of the golf ball occurs. Therefore, the position of the golf ball at the time of stopping the golf ball is slightly different from the position of the golf ball at the time of trigger (hereinafter referred to as “position difference”), and if it is stored as an average value or other statistical value of the position difference, it is possible to use this to correct the actual position of the golf ball to the correct position.

For example, in the case of FIG. 10(c), it is possible to specify a position corresponding to the average value of the position difference as described above from the position P1a of the golf ball at the trigger time point within a certain range of section RB on the line AL in the camera's gaze direction as the correct initial position of the golf ball.

Therefore, by converting the actual golf ball position determined as described above into coordinates on the image, the converted coordinates can be determined as corrected for the coordinates of the initial ball position initially obtained.

FIG. 11 shows a ball trajectory shown based on the coordinates of the initial ball position originally calculated in the single camera image IM of the golf ball flying as the user hits the golf ball and another ball trajectory shown by correcting the coordinates of the initial ball position to a more accurate position.

In the image shown in FIG. 11, iB2 represents a ball object that was initially placed.

The point indicated by the drawing code ‘pb2a’ in the image IM shown in FIG. 11 corresponds to the coordinates of the initial ball position initially calculated using the ball sensing area, and based on this, the ball trajectory calculated according to the radar sensing result of the golf ball is the trajectory referred to by iTr1.

As shown in FIG. 11, since the pb2a position, which is the coordinate of the initial ball position, was an error position when verified through radar sensing data at the trigger time point, the iTr1 ball trajectory starting from the coordinate pb2a of the initial ball position in the image IM is somewhat different from the actual trajectory.

The present invention, when it is determined that there is an error as a result of verifying the coordinates of the initial ball position using radar sensing data as described above, corrects the error to calculate the coordinates of the accurate initial ball position and displays the ball trajectory based on the corrected position coordinates.

The position where the coordinate pb2a of the initial ball position initially obtained in FIG. 11 is corrected to a more accurate position using radar sensing data at the trigger time point is the position indicated by the drawing code “pb2b”, and it can be seen that the ball trajectory iTr2 starting from the pb2b position is the correct ball trajectory.

As described above, the present invention has the advantage of being able to determine more accurate initial ball position coordinates by verifying and correcting the coordinates of the initial ball position initially obtained using radar sensing data in the image of the user's golf shot acquired by the single camera, and visualizing the accurate ball trajectory starting from the corrected position coordinates on the image.

Previously, a configuration and a method capable of more accurately determining the coordinates of the initial ball position by verifying and correcting the coordinates of the initial ball position initially obtained by the radar sensing-based ball trajectory visualization device according to an embodiment of the present invention have been described. In this regard, the ball trajectory visualization device according to another embodiment of the present invention may provide a configuration and a method capable of determining an accurate coordinate of an initial ball position from the beginning by using preset information before sensing.

As described above, since the coordinates of the initial ball position are calculated using the single camera, the present invention is not based on the position coordinates of the golf ball in a three-dimensional space. For example, when a user actually places the golf ball on a tee and takes a golf shot, an error as high as the tee height occurs when the coordinates of the initial ball position are obtained by analyzing the image taken with the single camera. The present invention corrects the error by verifying the initially obtained coordinates of the ball position using radar sensing data.

Furthermore, the ball trajectory visualization device according to another embodiment of the present invention can provide a more accurate function to calculate the coordinates of the initial ball position from the beginning by setting the height of the tee in advance when using the tee as described above and calculating the coordinates of the initial ball position in consideration of the height on the image corresponding to the preset tee height.

Specifically, the ball trajectory visualization device according to another embodiment of the present invention may have a configuration in which GPS can detect current location information or current location information using other sensors, and may be configured to store topographic or map information of a golf course where a current user plays a golf game in advance or recognize it through communication with a server.

With this configuration, the ball trajectory visualization device according to another embodiment of the present invention may recognize the position of a hole in a golf course currently playing a golf game, and may also know whether the hole is a PAR 3 hole, a PAR 4 hole, or a PAR 5 hole.

Before playing golf, the user may set the height of the tee to be used in each hole of the golf course using the ball trajectory visualization device according to another embodiment of the present invention in advance (the user may download and the device may recognize the tee height information stored in advance through the server, or the user may directly input the device and set it in advance).

For example, the user can set a tee height of 1.5 cm for the second hole (PAR 3 hole), a tee height of 4.5 cm for the third hole (PAR 4 hole), and a tee height of 4.5 cm for the fourth hole (PAR 5 hole).

Therefore, the ball trajectory visualization device according to another embodiment of the present invention can recognize the location of the hole on the golf course currently playing golf, recognize the user's tee height to be used in the current hole, and calculate the exact coordinates of the initial ball position in consideration of the height on the image for the preset and recognized tee height when calculating the coordinates of the initial ball position through the image taken by the single camera.

As described above, the coordinates of the initial ball position calculated in consideration of the tee height can eliminate or significantly reduce the aforementioned error, and even if the coordinates of the initial ball position are calculated in consideration of the tee height, it is also possible to calculate the coordinates of the initial ball position more accurately by additionally correcting through verification using radar sensing data.

If a plurality of users commonly use the ball trajectory visualization device according to the present invention when the users play golf together, the present invention may store that each user has set tee height information, and when a specific user takes a golf shot, a caddie or another user sets a user to shoot a current shot on a golf terminal, etc., the user's shot order information can be received from the golf terminal and the tee height information set in advance by the user can be applied. In this way, it is possible to apply the tee height set individually for each of the plurality of the users to the visualization of each individual golf shot image.

Meanwhile, a method for visualizing ball trajectory in an image of a user's golf shot according to an embodiment of the present invention will be described with reference to flowcharts of FIGS. 12 and 13.

A method for visualizing the ball trajectory in the user's golf shot image using the radar sensing-based ball trajectory visualization device according to an embodiment of the present invention has already been described in detail with reference to FIGS. 1 to 11, but a method for visualizing the ball trajectory will be summarized and described once again through the flowcharts shown in FIGS. 12 and 13.

The flowchart shown in FIG. 12 is connected to the flowchart shown in FIG. 13 through the reference symbol A to indicate one process as a whole.

First, a radar sensing-based ball trajectory visualization device according to an embodiment of the present invention is placed and positioned at a certain position behind the bottom where the user will perform a golf shot (S100).

The sensing processor of the ball trajectory visualization device may store coordinate matching information by matching coordinates of elements capable of specifying an area of a predetermined size on an image acquired by the single camera with coordinates on actual space, and set the area specified by the coordinates of the elements with the predetermined size on the image as a ball sensing area (S110).

The user places the golf ball at an arbitrary location on the bottom within the field of view of the single camera and prepares for a golf shot, where the single camera acquires the image, and the sensing processor searches for the preset ball sensing area in the image acquired by the single camera (S120).

If a ball object corresponding to the golf ball placed on the bottom is detected as a result of the search for the ball sensing area (S130), the sensing processor may calculate the detected position coordinates of the ball object as coordinates of initial ball position using coordinate information on the ball sensing area (S140).

The sensing processor may convert the coordinates of the initial ball position into the actual initial position coordinates of the golf ball using coordinate matching information so as to transmit the converted coordinates to the radar sensor (S150).

After that, when the user hits the golf ball with the golf club (S160), the ball trajectory visualization device first generates a trigger signal (S170), and the radar sensor operates according to the trigger signal.

The radar sensor may transmit radar signal toward the moving golf ball and receive the reflected wave signal reflected from the moving golf ball to collect golf ball orientation information including the vertical height angle of the golf ball and the horizontal direction angle of the golf ball at the time of measurement (S180).

The trajectory displaying processor of the ball trajectory visualization device may verify the coordinates of the initial ball position or the actual initial position coordinates of the golf ball based on the same using the golf ball orientation information calculated by the radar at the trigger time point or the trigger time ball coordinates at which the orientation information is converted into coordinates on an image (S200). For example, it is possible to determine whether the ball initial position coordinates calculated in step S140 are correct position coordinates.

As a result of the above verification, if it is determined that there is no error in the coordinates of the initial ball position calculated in step S140 and correction is not necessary (S210), the trajectory displaying processor may display the ball trajectory starting from the coordinates of the initial ball position on the image by converting the golf ball orientation information collected by the radar sensor into coordinates on the image based on the coordinates of the initial ball position (S220).

However, if there is an error in the ball initial position coordinates calculated in step 140 and it is determined that the ball initial position coordinates need to be corrected (S210), the trajectory displaying processor may correct the coordinates of the initial ball position calculated in step S140 to the correct position coordinates according to the verification results (S230).

Additionally, the trajectory displaying processor can display the ball trajectory starting from the coordinates of the initial ball position corrected to a more accurate position on the image by converting the golf ball orientation information collected by the radar sensor into coordinates on the image based on the coordinates of the initial ball position corrected in step S230 above (S240).

Although not shown in the flowchart on the drawing, the sensing processor of the present invention may calculate accurate information by presetting the tee height to be used by the user and applying the preset tee height information when calculating the coordinates of the initial ball position in step S140, as described above.

As described above, the method for visualizing ball trajectory in an image of the user's golf shot and the ball trajectory visualization device based on radar sensing using the same according to the present invention have an advantageous effect that can detect an initial position of a golf ball placed on a ground for a golf shot by the user using a camera-captured image for photographing the user's golf shot and providing it to the user, and visualize the movement trajectory of the golf ball calculated using the radar sensing result for the golf ball moving by the hit as an accurate ball trajectory starting from the initial position of the golf ball in the image. Furthermore, the present invention verifies whether there is an error in the coordinates of the initial ball position calculated from the image using radar sensing data, and if there is an error, corrects it to a more accurate coordinates of the initial ball position, and visualizes the accurate ball trajectory starting from the corrected position.

### INDUSTRIAL APPLICABILITY

A method for visualizing ball trajectory in an image of a user's golf shot and a ball trajectory visualization device based on radar sensing using the same according to the present invention can be used in golf-related industries such as sensing technology for golf balls, golf practice, and screen golf systems.

1. A method for visualizing ball trajectory in an image captured by a camera while a user hits a golf ball with a golf club using radar sensing results, the method comprising:
setting a ball sensing area for sensing the golf ball using the camera-captured image on a ground where the user will make a golf shot;
detecting a ball object corresponding to the golf ball within the ball sensing area on the camera-captured image to calculate coordinates of an initial ball position, and determining coordinates of an actual initial position of the golf ball corresponding to the coordinates of the initial ball position;
collecting radar sensing data for the golf ball moving according to the user's golf shot based on the coordinates of the actual initial position of the golf ball; and
displaying a ball trajectory starting from the coordinates of the initial ball position or corrected coordinates of the initial ball position in the camera-captured image using the collected radar sensing data for the golf ball.

2. The method according to claim 1, wherein the camera is a single camera with a single view, and the setting the ball sensing area includes:
storing coordinate matching information by matching coordinates of elements capable of specifying an area of a predetermined size on the image captured by the single camera with coordinates in actual space, and setting the area of the predetermined size on the image as the ball sensing area.

3. The method according to claim 1, wherein the camera is a single camera with a single view, and the setting the ball sensing area includes:
storing coordinate matching information by matching the coordinates of elements capable of specifying dimensions of a structure that appears in the image captured by the single camera from the rear with a field of view that includes the structure whose dimensions are known in advance on the ground where the golf shot will be made, with coordinates in actual space, and setting the area corresponding to the structure that appears in the image as the ball sensing area.

4. The method according to claim 2, wherein the determining coordinates of the actual initial position of the golf ball includes:
detecting the ball object corresponding to the golf ball within the set ball sensing area on the image captured by the single camera,
determining the position coordinates of the ball object as the coordinates of the initial ball position using coordinate information on the ball sensing area,
converting the coordinates of the initial ball position into the coordinates of the actual initial position of the golf ball, which are the actual spatial coordinates of the golf ball, using the coordinate matching information.

5. The method according to claim 4, further comprising pre-setting a height of a tee to be used by the user when making a golf shot,
wherein the calculating the position coordinates of the ball object as the ball initial position coordinates comprises:
recognizing the preset tee height;
applying height information from the image corresponding to the recognized tee height to the position coordinates of the ball object detected within the ball sensing area to calculate the coordinates of the initial ball position coordinates.

6. The method according to claim 1, wherein the collecting radar sensing data for the moving golf ball includes collecting golf ball orientation information including a horizontal direction angle and a vertical height angle the golf ball in the actual space at the time of receiving the radar signal reflected from the golf ball, and
wherein the displaying the ball trajectory includes displaying the ball trajectory starting from the coordinates of the initial ball position by converting each collected golf ball orientation information into coordinate information on the camera-captured image based on the coordinates of the initial ball position and connecting the converted coordinates.

7. The method according to claim 1, wherein the displaying the ball trajectory includes:
verifying the coordinates of the initial ball position on the camera-captured image using radar sensing data at the time the golf ball is hit;
correcting the coordinates of the initial ball position based on the result of the verification; and
converting radar sensing data collected for the golf ball moving from an impact time of the golf ball into coordinate information on the camera-captured image to display the ball trajectory starting from the corrected coordinates of the initial ball position on the image.

8. The method according to claim 1, wherein the collecting radar sensing data for the moving golf ball includes:
generating a trigger signal at the time point of hitting the golf ball; and
collecting golf ball orientation information including an up-down height angle and a left-right direction angle of the golf ball moving in actual space from the time point of generation of the trigger signal at the time of receiving the radar signal reflected from the moving golf ball, and
wherein the displaying the ball trajectory includes:
converting the golf ball orientation information at the time of generation of the trigger signal into coordinate information on the camera-captured image based on the coordinates of the initial ball position to generate ball coordinates at the trigger time point;
correcting the coordinates of the initial ball position using the ball coordinates at the trigger time point; and
converting the golf ball orientation information collected for the moving golf ball from the trigger time point into coordinate information on the camera-captured image based on the corrected coordinates of the initial ball position, and displaying the ball trajectory starting from the corrected coordinates of the initial ball position by connecting the converted coordinates.

9. The method according to claim 1, wherein the collecting radar sensing data for the moving golf ball includes:
generating a trigger signal at the time point of hitting the golf ball; and
collecting golf ball orientation information including an up-down height angle and a left-right direction angle of the golf ball moving in actual space from the time point of generation of the trigger signal at the time of receiving the radar signal reflected from the moving golf ball, and
wherein the displaying the ball trajectory includes:
determining three-dimensional position information of the golf ball at the time of generating the trigger signal using the golf ball orientation information at the time of generating the trigger signal and the actual initial position coordinates of the golf ball;
converting the calculated three-dimensional position information of the golf ball into coordinate information on the camera-captured image to calculate corrected coordinate information of the coordinates of the initial ball position; and
converting the golf ball orientation information collected for the moving golf ball from the trigger time point into coordinate information on the camera-captured image based on the corrected coordinates of the initial ball position, and displaying the ball trajectory starting from the corrected coordinates of the initial ball position by connecting the converted coordinates.

10. A ball trajectory visualization device based on radar sensing comprising:
a single camera capturing an image of a user performing a golf shot from behind a bottom on which the user is to perform the golf shot;
a sensing processor that sets a ball sensing area for sensing a golf ball using the image captured by the single camera, detects a ball object corresponding to the golf ball within the ball sensing area on the captured image to calculate coordinates of initial ball position, and determines actual initial position coordinates of the golf ball corresponding to the coordinates of the initial ball position;
a radar sensor that collects radar sensing data for the golf ball moving according to the user's golf shot based on the actual initial position coordinates of the golf ball; and
a trajectory displaying processor that displays a ball trajectory starting from the coordinates of the initial ball position or corrected coordinates of the initial ball position in the camera-captured image using the collected radar sensing data for the golf ball.

11. The ball trajectory visualization device according to claim 10, wherein the sensing processor is configured to:
match coordinates of elements capable of specifying dimensions of a structure on the image captured by the single camera with a field of view including the structure with known the dimensions placed on the bottom, with coordinates in actual space to store coordinate matching information;
set an area corresponding to the structure shown on the image as the ball sensing area;
detect a ball object corresponding to the golf ball within the set ball sensing area on the image captured by the single camera;
determine the position coordinates of the ball object as coordinates of the initial ball position using coordinate information on the ball sensing area; and
convert the coordinates of the initial ball position into the actual initial position coordinates of the golf ball, which is the actual spatial coordinates of the golf ball, using the coordinate matching information.

12. The ball trajectory visualization device according to claim 10, wherein the sensing processor is configured to:
preset a height of a tee to be used when the user takes a golf shot;
match coordinates of elements capable of specifying dimensions of a structure on the image captured with a field of view including the structure with known the dimensions placed on the bottom, with coordinates in actual space to store coordinate matching information;
set an area corresponding to the structure shown on the image as the ball sensing area;
detect a ball object corresponding to the golf ball within the set ball sensing area on the image captured by the single camera;
calculate the position coordinates of the ball object using coordinate information on the ball sensing area;
recognize the preset tee height and apply the height information on the image corresponding to the recognized tee height to the position coordinates of the ball object to calculate the coordinates of the initial ball position; and
convert the coordinates of the initial ball position into the actual initial position coordinates of the golf ball, which is the actual spatial coordinates of the golf ball, using the coordinate matching information.

13. The ball trajectory visualization device according to claim 10, wherein the radar sensor is configured to collect golf ball orientation information including a vertical height angle and a horizontal direction angle on the actual space of the golf ball at the time of receiving the radar signal reflected from the golf ball, and
wherein the trajectory displaying processor is configured to convert each golf ball orientation information collected by the radar sensor into coordinate information on the camera-captured image based on the coordinates of the initial ball position and connect the converted coordinates to display the ball trajectory starting from the coordinates of the initial ball position.

14. The ball trajectory visualization device according to claim 10, wherein the trajectory displaying processor is configured to:
verify the coordinates of the initial ball position on the camera-captured image using radar sensing data at the time when the golf ball is hit, and correct the coordinates of the initial ball position according to the verification result; and
convert the radar sensing data collected for the moving golf ball from the time point of hitting into coordinate information on the camera-captured image to display a ball trajectory starting from the corrected coordinates of the initial ball position on the image.

15. The method according to claim 3, wherein the determining coordinates of the actual initial position of the golf ball includes:
detecting the ball object corresponding to the golf ball within the set ball sensing area on the image captured by the single camera,
determining the position coordinates of the ball object as the coordinates of the initial ball position using coordinate information on the ball sensing area,
converting the coordinates of the initial ball position into the coordinates of the actual initial position of the golf ball, which are the actual spatial coordinates of the golf ball, using the coordinate matching information.
